(19) United States
(12) Patent Application Publication
(10) Pub. No.: US 2023/0212845 A1
(43) Pub. Date: Jul. 6, 2023

(54) HAIR TREATMENT CARTRIDGES FOR FUNCTIONAL SHOWERHEAD

(71) Applicant: L'Oreal, Paris (FR)

(72) Inventors: Ji Lee, New York, NY (US); Mohamed Kanji, Clark, NJ (US)

(73) Assignee: L'Oreal, Paris (FR)

(21) Appl. No.: 18/059,680

(22) Filed: Nov. 29, 2022

Related U.S. Application Data
(60) Provisional application No. 63/295,267, filed on Dec. 30, 2021.

(30) Foreign Application Priority Data
Mar. 30, 2022 (FR) 2202883

(51) Int. Cl. E03C 1/046

(52) U.S. Cl. CPC E03C 1/046

(57) ABSTRACT

A system for dispensing hair care, the system including a dispensing device, at least one cartridge containing a hair care material configured to fit inside the dispensing device, a dispensing container removably attached to the dispensing device wherein the dispensing container is configured to accept a specified amount of the hair care material from the at least one cartridge, and a showerhead communicatively coupled to the dispensing device and configured to connect to the dispensing container.

### CROSS-REFERENCES TO RELATED APPLICATIONS

The present application claims priority to and the benefit of U.S. Provisional Application No. 63/295267, filed Dec. 30, 2021, and French Application No. 2202883, filed Mar. 30, 2022, the entire disclosures of which are hereby incorporated by reference herein in their entirety for all purposes.

### SUMMARY

The following describes a device for dispensing personalized hair care formulas for use at home communicatively coupled to a communication device and a functional showerhead. In some embodiments, a dispensing container of the dispensing device is connected to a functional showerhead, so as to deposit hair care material onto a user's hair while showering. In some embodiments, the functional showerhead can communicate with the communication device and the dispensing device to ensure the proper hair care materials are being deposited and detect the doses of hair care material inside the dispensing container.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an overall perspective view of an example hair care dispensing device, in accordance with the present technology;

FIG. 2 is an example cartridge, in accordance with the present technology;

FIG. 3 is a top-down view of an example base of a hair care dispensing device, in accordance with the present technology;

FIG. 4 is an example hair care system, in accordance with the present technology;

FIG. 5A-5C are example shower heads, in accordance with the present technology; and

FIG. 6 is a flowchart of an example method of depositing a hair care material with a functional showerhead, in accordance with the present technology.

### DETAILED DESCRIPTION

While illustrative embodiments have been illustrated and described, it will be appreciated that various changes can be made therein without departing from the spirit and scope of the invention.

The system for dispensing hair care materials disclosed below is configured to work in conjunction with an AI-enabled, motorized cartridge system that creates personalized hair care materials. In operation, the user may take a photo, or upload a photo, of their hair with a communication device, such as a smartphone camera, and open an application (“app”) on the smartphone. In some embodiments, the app on the communication device uses AI to analyze the user's hair, including but not limited to the overall hair condition, damage, color, copper content, lice presence, moisture, texture, and/or dandruff. In some embodiments, the app also assesses environmental conditions that can influence the state of the user's hair. Example conditions include, but are not limited to, UV index, air quality, pollen, weather, temperature, and humidity.

In some embodiments, the app also assesses user inputs, including current hair color, past hair treatments, hair length, and hair texture. In some embodiments, the user can select specific hair concerns, such as moisture, curl, texture, UV protection, or color.

In some embodiments, a personalized blend of high-performance hair care is then dispensed in a portioned dose at the top of the device, into a dispensing container. In some embodiments, this dose is a single dose for a single application. In some embodiments, this is enough doses for a weekly number of applications, such as seven doses for seven days of the week. In some embodiments, one or more hair care blends is dispensed. In some embodiments, the dispensing device can dispense hair care materials including, but not limited to, shampoo, conditioner, serum, hair masks, lice treatment, leave-in hair care materials, and mousse.

In some embodiments, the dispensing system is configured to accept three cartridges containing hair care material, but in other embodiments, the number of cartridges can be larger or smaller. In some embodiments, the cartridges slide into the dispensing device. In some embodiments, the cartridges click into the dispensing device. In some embodiments, the cartridges may contain one or more active ingredients beneficial for hair care, such as zinc oxide, tea tree oil, etc. In some embodiments, the cartridges are color coded or shaped in a specific manner to allow a user to better distinguish them from one another. In some embodiments, the cartridges are RFID tagged or QR coded so that the dispensing device can determine what hair care material is inside the cartridge.

In some embodiments, the dose of hair care formula is a single dose. In some embodiments, the user can double or triple this dosage with an additional touch. In some embodiments, the dispensing device can prescribe a weekly regimen that the user can dispense daily. In some embodiments, the dose of hair care formula is enough hair care formula for the entire weekly regimen.

In some embodiments, the system further includes a functional showerhead (“showerhead”) for depositing the hair care material onto the user's hair. The dispensing container of the dispensing device can be connected to the showerhead, so that when the shower is turned on, the hair care material in the dispensing container is deposited onto a user's hair, which may save water. In some embodiments, the user can actuate a user input to deposit the hair care material while the water is running. In some embodiments, the showerhead includes a controller to detect the type of hair care material inside the dispensing chamber, detect the number of doses of hair care material inside the dispensing chamber, or control the amount or rate of flow of the hair care material. In some embodiments, the detection of the type and amount of hair care material in the dispensing container can be informed by the communication device and/or the dispenser.

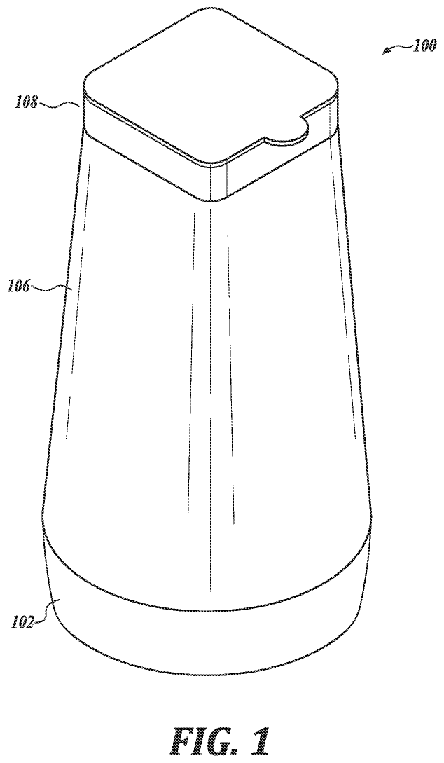

FIG. 1 is an overall perspective view of an example hair care dispensing device 100, in accordance with the present technology. The visible portion of the hair care dispenser 100 includes a base 102. The base 102 provides a support for a dispenser body 106. In some embodiments, the base 102 provides power to the device, such as with an electrical cord (not shown in FIG. 1). A dispensing container 108 is disposed above the dispenser body 106. A power button, (not shown in FIG. 1), may be disposed partly within the dispenser body 106 such that the dispenser body 106 secures placement of the power button and an indicator light and button (not shown in FIG. 1) may be disposed partly within the dispenser body 106 such that the dispenser body 106 secures placement of the indicator light and button. The indicator light and button may be a mechanical or capacitive touch-type button. The dispenser body 106 may provide a base for the dispensing container 108.

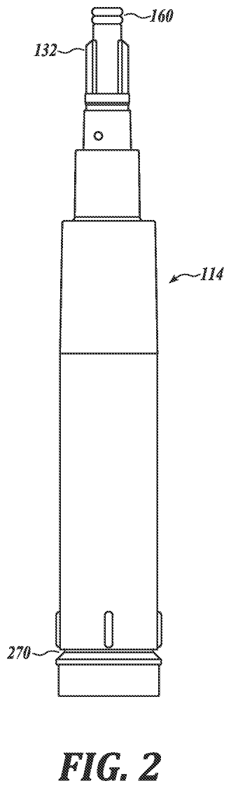

FIG. 2 is an example cartridge, in accordance with the present technology. The cartridge 114 has a round, cylindrical body, and a nozzle 160 at a first end. The nozzle 160 is further disposed near a cartridge key 132. The cartridge 114 contains and dispenses an amount of hair care material into the dispensing container 108 as needed. In some embodiments, the cartridge 114 dispenses hair care material by rotation of a cartridge gear while the cartridge 114 remains in place substantially vertically along the Y-axis. A circumferential groove 270 is at a second end of the cartridge 130 and is used to secure the cartridge 114 into the dispensing device 100.

An amount of hair care material is released from the cartridge 114 through the nozzle 160 by a first rotational motion of the first end with respect to the second end of the cartridge 114. Rotational motion of the first end of the cartridge 114 in a second direction, opposite of the first rotational motion, may close the nozzle 160 of the cartridge 114.

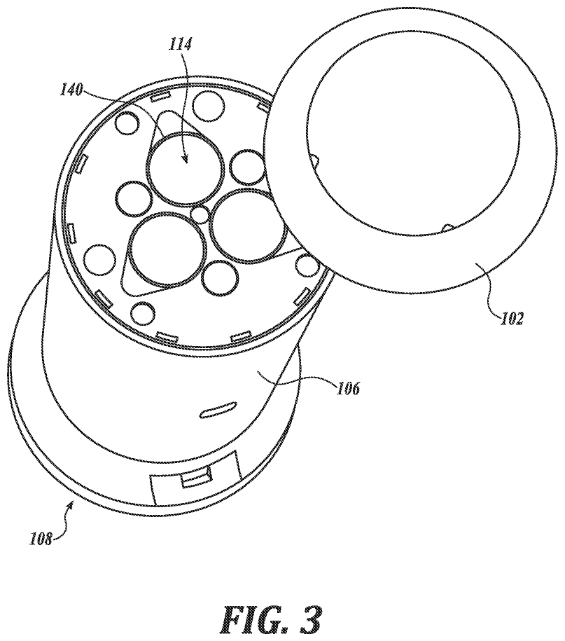

FIG. 3 is a top-down view of an example base of a hair care dispensing device, in accordance with the present technology. The base 102 may be connected to the body 106 of the dispensing device 100 in a manner that allows it to be rotated open to expose a plurality of cartridge openings 140. In some embodiments, the base 102 is removed completely to access the cartridge openings 140. In some embodiments, the base 102 is attached to the body 106 with a hinge, screw, magnet, or other mechanism for attachment. As illustrated, one or more cartridges 130 can be inserted into the plurality of cartridge holes 140. Though three cartridge holes 140 are illustrated in FIG. 3, any number of cartridge holes 140 can be in the body 106 of the dispensing device 100.

A nozzle 160 of each cartridge 114 is disposed inside one of the cartridge holes 140. Various additional substructures and covers may be disposed between the internal components of the hair care dispenser 100 and the dispenser body 106.

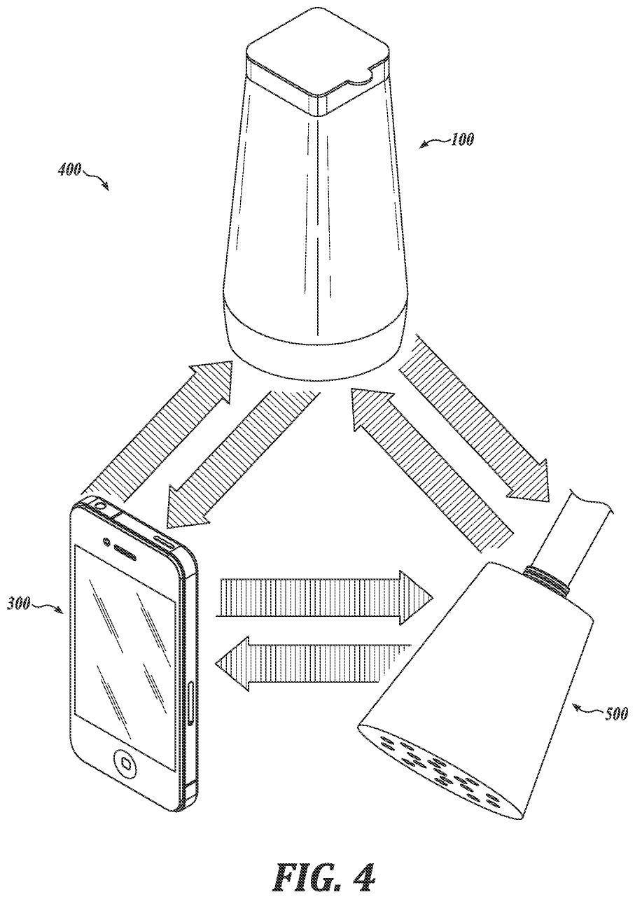

FIG. 4 is an example hair care dispensing system, in accordance with the present technology. A system 400, which implements the hair care dispenser 100 described herein, includes at least the hair care dispenser 100, a connected communication device 300, and a connected functional showerhead 500. Optionally, the system may further include one or more external servers (not pictured) which are implemented as part of a cloud-computing environment.

The connected communication device 300 may be a personal computer (PC), a laptop computer, a PDA (Personal Digital Assistants), a smart phone, a tablet device, a UMPC (Ultra Mobile Personal Computer), a net-book, or a notebook type personal computer. In the below examples, the connected device 300 is assumed to be a tablet device, such as an Apple iPad.

The connected communication device 300 is capable of performing wireless communication with the hair care dispenser 100 and the functional showerhead 500 by way of a wireless communication interface circuitry on the hair care dispenser 100 and similar circuitry in the functional showerhead 500. However, communication device 300 is also capable of having a wired connection to the hair care dispenser 100 by way of a USB interface on the apparatus 100. Additionally, each device, including the hair care dispensing device 100, may communicate with each other and the external one or more devices through an internet connection via an 802.11 wireless connection to a wireless internet access point, or a physical connection to the internet access point, such as through an Ethernet interface. Each connected communication device 300 is capable of performing wireless communication with other devices, such as through a Bluetooth connection or other wireless means as well.

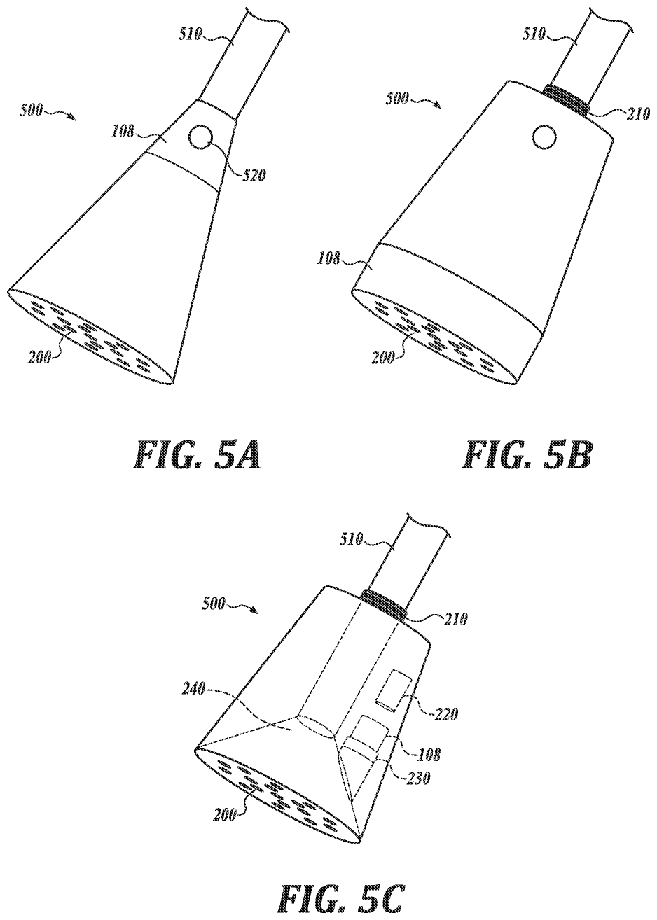

The connected communication device 300 is configured to receive information from a user for use in generating a hair care material that will be used by the hair care dispenser 100 to dispense hair care material into a dispensing container 108, as shown in FIGS. 5A-5C.

The functional showerhead 500 is likewise capable of performing wireless communication with the hair care dispenser 100 by way of a wireless communication interface circuitry in the hair care dispenser 100. The functional showerhead is capable of communicating to the hair care dispenser 100 and the communication device 300 regarding the dispensing containers currently inserted in the showerhead 500 (as described in more detail below).

FIG. 5A-5C are example showerheads 500 in accordance with the present technology. While the showerheads 500 are illustrated as conically shaped, the showerhead 500 may be any shape, such as cylindrical. In some embodiments, the showerhead 500 includes a plurality of nozzles 200. While the plurality of nozzles 200 are illustrated as being round and scattered across the base of the showerhead 500, the plurality of nozzles 200 may take any configuration, shape, or pattern. In some embodiments, the showerhead 500 includes a battery (not illustrated in FIGS. 5A-5C) for powering the showerhead and dispensing hair care material from the dispensing container 108.

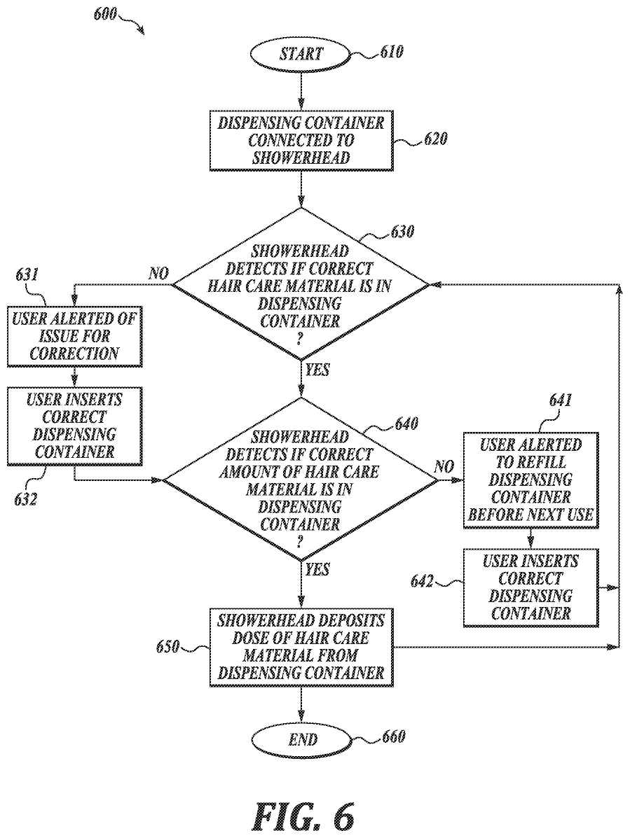

In some embodiments, the showerhead 500 includes a user input 520 that the user can actuate. In some embodiments, the user input 520 is a button, a switch, or a touchpad. In some embodiments, the user can actuate the user input 520 to begin the detecting process (as explained in detail in FIG. 6). In some embodiments, the user can actuate the user input 520 to deposit the hair care material. In some embodiments, the user can actuate the user input 520 to perform both of these functions, one after the other.

FIG. 5A is an example of a mode of connecting the dispensing container 108 to the functional showerhead 500. The showerhead 500 includes a plurality of nozzles 200. In some embodiments, the showerhead 500 further includes a controller (as shown in FIG. 5C). As illustrated in FIG. 5A, in some embodiments, the dispensing container 108 is connected to the showerhead 500 between the spout 510 of a shower and the showerhead 500 itself. The dispensing container may include an attachment, such as a threaded opening to attach to the spout 510 of a shower, and a second attachment to connect to the showerhead 500.

In operation, as water flows through the spout 510 it commingles with the hair care material in the dispensing container and is eventually pushed through the plurality of nozzles in the showerhead 500, depositing the hair care material onto the hair of a user while showering. In some embodiments, the user actuates user input 520 to deposit the hair care material.

FIG. 5B is an example of another mode of connecting the dispensing container 108 to the functional showerhead 500. The showerhead 500 includes an attachment 210 for connecting to the spout 510 of the shower. In some embodiments, the showerhead 500 includes a controller, as illustrated in FIG. 5C. In some embodiments, the dispensing container 108 is attached to the base of the showerhead 500. In some embodiments, the dispensing container 108 may be attached to the showerhead 500 with a magnet, a threaded opening, or a snap. In some embodiments, the dispensing container 108 may include a plurality of nozzles 200 for dispensing the hair care material.

In operation, as water flows through the spout 510 of the shower, and through the showerhead 500, it reaches the dispensing container 108, commingles with the hair care material inside the dispensing container 108, and deposits the hair care material onto a user's hair through the plurality of nozzles 200 while the user is showering. In some embodiments, the user can actuate the user input 520 to deposit the hair care material.

FIG. 5C is an internal view of another example of a mode of connecting the dispensing container 108 to the functional showerhead 500. The showerhead 500 includes a chamber 240, a plurality of nozzles 200, a controller 220, and a dispensing container 180. In some embodiments, the showerhead 500 further includes a cover 230. In some embodiments, the dispensing container 108 is inserted inside the showerhead 500. While the dispensing container 108 is illustrated as being inserted into the right side of the showerhead 500, the dispensing container 108 could also be inserted into the left side of the showerhead 500, or any other internal location of the showerhead 500. Further, while one flow path of water is illustrated in FIG. 5C, it should be understood that any number of flow paths could be utilized.

In operation, the controller 220 is communicatively coupled to the dispensing container 108 and the cover 230. As water flows from the spout 510 into the chamber 240 of the showerhead 500, the controller 220 may direct the cover 230 to open, so that a hair care material flows out of the dispensing container 108 in a controlled manner. As the hair care material commingles with the flowing water, it is deposited onto a user's hair through the plurality of nozzles 200 while the user showers. In some embodiments, the user must actuate the user input 520 to deposit the hair care material. In some embodiments, the cover 230 may slide to expose an opening on the dispensing container 108. In some embodiments, the cover 230 may be attached to the dispensing container 108 and inserted into the showerhead 500 at the same time as the dispensing container 108.

In some embodiments, the controller 220 is also able to detect how much hair care material is left in the dispensing container 108 and alert the user to refill the dispensing container 108 through a communication device (such as communication device 300), as described in more detail below. In some embodiments, the controller 220 is also communicatively coupled to the user input 520 (not illustrated in FIG. 5C) to receive input from a user to begin the detecting process and/or to deposit hair care material.

FIG. 6 is a flowchart of an example method of depositing a hair care material with a functional showerhead in accordance with the present technology. The method begins in block 610.

In block 620, a dispensing container, such a dispensing container 108, is connected to a showerhead, such as showerhead 500. In some embodiments, the dispensing container is connected to the showerhead as shown in FIGS. 5A-C.

In block 630, the showerhead detects if the correct hair care material is in the dispensing container. In some embodiments, the showerhead automatically proceeds to block 630. In some embodiments, a user initiates block 630 by actuating a user input, such as user input 520. In some embodiments, the user initiates block 630 through an application on the communication device. In some embodiments, the showerhead detects if the correct hair care material is in the dispensing container. The detecting processes 630 and 640, and the depositing process 650 are performed by the showerhead based on commands received from a controller, (not shown) the controller sending data to and receiving input from the user through the communication device or by indicators on the showerhead itself.

The showerhead may determine if the hair care material is a correct hair care material by communicating with a communication device (such as communication device 300) and/or a dispensing device (such as dispensing device 100) to determine what hair care material had been dispensed last. In some embodiments, the showerhead can determine if the hair care material is the correct hair care material based on the shape of the dispensing container, or a marker on the dispensing container such as a QR code or an RFID tag.

If an incorrect hair care material is detected, the method proceeds to block 631. In block 631, the user is alerted to the incorrect hair care material and given an opportunity to correct. In some embodiments, the user is alerted through an application on the communication device 300. In some embodiments, the user is alerted to the incorrect hair care material by the showerhead itself, such as through a blinking LED, a noise or tone, or a user interface. Once the user inserts the correct dispensing container in block 632, the method proceeds to block 640.

If the correct hair care material in the dispensing container was inserted into the showerhead the first time, the method also proceeds to block 640.

In block 640, the showerhead detects if the correct amount of hair care material is inside the dispensing container. In some embodiments, the showerhead is capable of sensing the amount of hair care material in the dispensing container. In some embodiments, the dispensing device and/or the communication device inform the showerhead as to how many doses of hair care material were dispensed into the dispensing container. The showerhead can then retain this information and count the doses as dispensed or inform the dispensing device and/or communication device whenever a dose has been deposited to keep a running total of remaining doses. In some embodiments, the showerhead determines that at least one dose of hair care material is inside the dispensing container.

If there is not enough hair care material in the dispensing container, i.e. if there is less than one dose, the method proceeds to block 641. In block 641, the user is alerted to refill the dispensing container. In some embodiments, the showerhead alerts the user to refill the dispenser in the methods described above, in block 631. In some embodiments, the user is alerted through a notification by the communication device 300. In block 642, the user inserts a refilled or new dispensing container into the showerhead. Once this is done, the method proceeds back to block 630 to ensure the hair care material is correct and the correct amount of hair care material is inside the dispensing chamber.

If the showerhead detects that the correct amount of hair care material is inside the dispensing container, i.e. at least one dose of hair care material, the method proceeds to block 650.

In block 650, the showerhead deposits a dose of the hair care material from the dispensing container onto the user's hair. In some embodiments, the user can turn on the shower so that water and the hair care material is deposited onto the user's hair. In some embodiments, the user actuates a user input on the showerhead to deposit the hair care material while the shower is on. Examples of user inputs include, but are not limited to, a button, switch, or touchpad. In some embodiments, the showerhead can regulate the amount of hair care material and the rate of hair care material deposited onto the user's hair. Optionally, if the user wishes to use a second dose of the hair care material, the method returns to step 620. In some embodiments, the dispenser container is single use, i.e. it contains a single dose of hair care material, and will have to be refilled after each use. In some embodiments, the dispenser container contains more than one dose, and can be used multiple times, until empty.

In block 660, the method ends.

The embodiments of the invention in which an exclusive property or privilege is claimed are defined as follows:

1. A system for dispensing hair care, the system comprising:
a dispensing device;
at least one cartridge containing a hair care material configured to fit inside the dispensing device;
a dispensing container removably attached to the dispensing device wherein the dispensing container is configured to accept a specified amount of the hair care material from the at least one cartridge; and
a showerhead communicatively coupled to the dispensing device and configured to connect to the dispensing container.

2. The system of claim 1, wherein the system further comprises a communication device communicatively coupled to the dispensing device and the showerhead.

3. The system of claim 1, wherein the dispensing container is configured to connect to the showerhead between a spout of the shower and the showerhead.

4. The system of claim 1, wherein the dispensing container is configured to connect to the base of the showerhead.

5. The system of claims 1, wherein the dispensing container is inserted inside the showerhead.

6. The system of claims 1, wherein the showerhead is further configured to detect a number of doses of hair care material present in the dispensing chamber.

7. The system of claim 6, wherein the showerhead detects the number of doses of hair care material present in the dispensing chamber by communicating with the dispensing device regarding a number of doses of the hair care material last dispensed.

8. The system of claim 6, wherein the showerhead detects the number of doses of hair care material present in the dispensing chamber by communicating with the communication device regarding a number doses of the hair care material last dispensed.

9. The system of any one of claims 1, wherein the showerhead is further configured to detect the type of hair care material inside the dispensing chamber.

10. The system of claim 9, wherein the showerhead detects the type of hair care material inside the dispensing chamber by reading an RFID tag on the dispensing container associated with the type of hair care material inside of the dispensing container.

11. The system of claim 9, wherein the showerhead detects the type of hair care material inside the dispensing chamber by reading a QR code on the dispensing container associated with the type of hair care material inside of the dispensing container.

12. The system of claim 9, wherein the showerhead detects the type of hair care material present in the dispensing chamber by communicating with the dispensing device regarding the type of hair care material last dispensed.

13. The system of claim 9, wherein the showerhead detects the type of hair care material present in the dispensing chamber by communicating with the communication device regarding the type of hair care material last dispensed.

14. The system of claim 1, wherein the showerhead is further configured to deposit a single dose of the hair care material.

15. The system of claim 1, wherein the dispensing container is single-use.
